(19) United States
(12) Patent Application Publication
(10) Pub. No.: US 2009/0125281 A1
(43) Pub. Date: May 14, 2009

(54) SYSTEM AND METHODS FOR DETERMINING SIZE, AND METHOD FOR PRODUCING A SIZE-DETERMINING SYSTEM

(76) Inventors: Nicolas Barjot, Terville (FR); Nicolas Belluye, Lille (FR)

Correspondence Address: LADAS & PARRY LLP, 224 SOUTH MICHIGAN AVENUE, SUITE 1600, CHICAGO, IL, 60604, US

(21) Appl. No.: 11/997,937

(22) PCT Filed: Aug. 7, 2006
(86) PCT No.: PCT/FR2006/001915

§ 371 Date: Aug. 8, 2008

(30) Foreign Application Priority Data
Aug. 5, 2005 (FR) 0508394

(51) Int. Cl. G06F 17/50

(52) U.S. Cl. 703/1

(57) ABSTRACT

The invention concerns a size-determining system and method of size grading type, used in particular to determine sizes, and a method to produce said system for a product to be worn on parts of the body, notably in the area of items for sub-aquatic vision.

The method to produce the system comprises selecting principal morphological parameters from among parameters corresponding to the distance between two morphological markers characteristic of the body part. It also comprises selecting product parameters corresponding to the distance between two geometrically characteristic points of the product, determining an arithmetical relationship between each product parameter and the principal morphological parameters, and determining sizes defined by particular variation intervals of the principal morphological parameters or product parameters.

The system comprises means to store values of the morphological parameters and product parameters, a module to calculate the value of product parameters in relation to the value of the principal morphological parameters, and means to store sizes defined by particular variation intervals of the principal morphological parameters or product parameters.

The method comprises calculation of the product parameter values, in relation to the values of the principal

morphological parameters which are determined by selecting a size from a group of sizes defined by variation intervals of the principal morphological parameters, and by assigning median values of the intervals to the corresponding principal morphological parameters.

The subject of this present invention is a size-determining system and method, as well as a method for the producing of a size-determining system. It finds particular application in the field of creating a sizing system for products that are intended to be worn on one or more parts of the body of a person. For example, but not exclusively, it can consist of articles for sub-aquatic vision, in particular such as swimming goggles, and swimming or diving masks.

In general, a product is offered for sale either in a single size or in several sizes.

When offered in a single size, it is obviously understood that the product will not necessarily be suitable for all users. A size, regardless of its definition, is generally determined statistically so that it will fit the greatest number. But the satisfaction rating, which is related to suitability of fit, will be relatively low, given the different possible morphology types, and the morphological differences within a given morphology type.

The problem is particularly difficult for products such as items for sub-aquatic vision e.g. swimming goggles, and swimming or diving masks. For such products, there is an important issue of comfort and leak-resistance properties. It is extremely difficult to design a product in a single size that affords a satisfactory level of comfort and leak-tightness for a large number of people, since face morphology differences can vary widely from one person to another.

Under these conditions, to improve the level of comfort of the product it is possible, for example, to include a foam gasket that follows the contour of the user's face as closely as possible to compensate for the poor fit of the single size. The problem then arises of poor leak-proof qualities due to this type of gasket.

Conversely, to achieve good leak resistance properties, it is possible to provide the product with a silicone gasket, since this will provide a better level of leak-tightness than a foam gasket. However the problem then will be a problem of discomfort for a certain number of users for whom the single size is ill-adapted.

It can therefore be appreciated that a product that is offered to users in several sizes will satisfy a greater number thereof.

Systems and methods known as size grading are already known for clothing, which are used to determine the characteristics of a certain number of sizes from a master pattern. For this master pattern, the geometrical characteristics of all parts of the garment are determined. Then, using empirical grading rules, particular to the garment under consideration and applied to the characteristic points of the garment, the characteristics of the other sizes are obtained. These rules concern variations in the coordinates of the characteristic points.

These systems and methods are complex and expensive however. They necessitate extensive calculations, based on empirical rules that are not necessarily appropriate. Additionally, they are not appropriate for products whose geometry or morphology does not directly reflect that of the part of the body on which these products are to be worn. In some cases, the correlation between the different geometries of certain parts of the body for a given size, and these same geometries for a different size is not necessarily a logical correlation.

This is the case, for example, with products such as items for sub-aquatic vision e.g. swimming goggles, and swimming or diving masks. In this case, these systems and methods do not allow a relationship to be established between certain morphological characteristics of the product and certain morphological characteristics of that part of the body on which the product is to be worn, nor do they allow a size to be determined, from among a set of possible sizes, that is best suited a given person.

The problem which therefore arises is the providing of a system and a method, based on a set of size parameters characteristic of the products, which can be used in particular to determine sizes having a high level of morphological coverage, so as to be able to determine the size, from among a group of possible sizes, that will fit an individual person.

The objective of the invention is therefore to provide a solution to the aforementioned problems, amongst others.

According to a first aspect therefore, the invention relates to a method to produce a sizing system for an item that is intended to be worn on at least one part of the body.

Characteristically, the method firstly includes a step to select one or more principal morphological parameters PMP_{i,j} from among one or more characteristic morphological parameters PM_{i,j} of that part of the body, and corresponding to the distance between two characteristic morphological markers Mᵢ, Mⱼ of this part of the body.

The method also includes a step to select at least one product parameter PP_{i,j} corresponding to the distance between two points NPᵢ, NPⱼ that are geometrically characteristic of the product, and a first determination step to determine an arithmetical relationship between each product parameter PP_{i,j} and at least one of the principal morphological parameters PMP_{i,j}.

It also includes a second determination step to determine an arithmetical relationship between the coordinates of each geometrically characteristic point NPᵢ of the product and at least one of said product parameters PP_{i,j}, these coordinates being expressed in a reference system centred on one particular point NP_{ref} from among the geometrically characteristic points NPᵢ of the product.

The method finally includes a step to determine one or more sizes, each of these sizes being determined by particular intervals of variation of the principal morphological parameter or parameters PMP_{i,j} respectively, or by particular intervals of variation of the product parameter or parameters PP_{i,j} respectively.

In a first variant, the first step to determine an arithmetical relationship between each product parameter PP_{i,j} and at least one of the principal morphological parameters PMP_{i,j}, for each product parameter PP_{i,j}, includes a step to determine arithmetical coefficients c⁰_{i,j} . . . cⁿ_{i,j}, such that:

PP_{i,j}=C⁰_{i,j}+c¹_{i,j}×PMP_{i1,j1}+c²_{i,j}×PMP_{i2,j2}+ . . . +cⁿ_{i,j}×PMP_{in,jn}

In a second variant, optionally in combination with the preceding variant, the first step to determine an arithmetical relationship between each product parameter PP_{i,j} and at least one of the principal morphological parameters PMP_{i,j} itself includes a first step for determining an arithmetical relationship between each morphological parameter PM_{i,j} and at least one of the principal morphological parameters PMP_{i,j}, and a second step to determine an arithmetical relationship between each product parameter PP_{i,j} and at least one of the morphological parameters PM_{i,j}.

The first step to determine an arithmetical relationship between each morphological parameter PM_{i,j} and at least one of the principal morphological parameters PMP_{i,j}, preferably then includes, for each morphological parameter PM_{i,j}, a step to determine arithmetical coefficients d⁰_{i,j}, . . . dⁿ_{i,j}, such that:

PM_{i,j}=d⁰_{i,j}+d¹_{i,j}×PMP_{i1,j1}+d²_{i,j}×PMP_{i2,j2}+ . . . +dⁿ_{i,j}×PMP_{in,jn}

Also preferably, the second step to determine an arithmetical relationship between each product parameter PP_{i,j} and at least one of the morphological parameters PM_{p,q}, for each product parameter PP_{i,j}, includes a step to determine an arithmetical coefficient e^{p,q}_{i,j} such that:

PP_{i,j}=e^{p,q}_{i,j}×PM_{p,q}

In another variant, optionally in combination with any one or more of the preceding variants, the variation intervals of the product parameters PP_{i,j} are defined by a tolerance that equal to or less than ±4%, and preferably equal to±3%, around a median value.

In another variant, optionally in combination with any one or more of the preceding variants, the part of the body being the face, the morphological parameters PMP_{i,j} are the biectocanthion distance, the biendocanthion distance, and the distance from the nasion to the subnasal point.

The following definitions are recalled. The ectocanthions are the points located at the external (lateral) palpebral angles, on the posterior ridge, and the biectocanthion distance is therefore the distance between the two ectocanthions of the face. The endocanthions are the points located at the internal (median) palpebral angles, outside of the lachrymal caruncle, and the biendocanthion distance is therefore the distance between the two endocanthions of the face. The nasion is the median point located at the junction of the root of the nose and the forehead. Finally, the subnasal point is the point located at the apex of the angle formed by the lower edge of the septum and the top lip.

In yet another variant, optionally in combination with any one or more of the preceding variants, the product 1 is an item for sub-aquatic vision.

According to a second aspect, the invention also relates to a sizing system for a product that is intended to be worn on at least one part of the body.

Characteristically, the system includes means to store the respective values of one or more characteristic morphological parameters PM_{i,j} of the part of the body, which correspond to the distance between two characteristic morphological markers Mᵢ, Mⱼ of that part of the body, at least one of these morphological parameters PM_{i,j} being a principal morphological parameter PMP_{i,j}.

The system also includes means to store the respective values of one or more product parameters PP_{i,j} geometrically characteristic of the product, and corresponding to the distance between two geometrically characteristic points NPᵢ, NPⱼ of the product, and a first module to calculate the value of each product parameter PP_{i,j} in relation to the value of at least one of the principal morphological parameters PMP_{i,j}.

It also includes a second module 6 to calculate the value of the coordinates of each geometrically characteristic point NPᵢ of the product, in relation to at least one of the product parameters PP_{i,j}, these coordinates being expressed in a reference system centred on a particular point NP_{ref} from among the geometrically characteristic points NPᵢ of the product.

Finally, the system includes means to store at least one size determined by particular variation intervals of the respective principal morphological parameter(s) PMP_{i,j}, or by particular variation intervals of the respective product parameter(s) PP_{i,j}.

In a first variant, the first calculation module is designed to perform the following calculation for each product parameter PP_{i,j}:

PP_{i,j}=c⁰_{i,j}+c¹_{i,j}×PMP_{i1,j1}+c²_{i,j}×PMP_{i2,j2}+ . . . +cⁿ_{i,j}PMP_{in,jn}

where c⁰_{i,j} . . . , cⁿ_{i,j} are predefined arithmetical coefficients.

In another variant, optionally in combination with the preceding variant, the first module to calculate the value of each product parameter PP_{i,j} in relation to the value of at least one of said principal morphological parameters PMP_{i,j} itself includes a first sub-module to calculate the value of each morphological parameter PM_{i,j} in relation to the value of at least one of the principal morphological parameters PMP_{i,j}, and a second sub-module to calculate the value of each product parameter PP_{i,j} in relation to the value of at least one of the morphological parameters PM_{i,j}.

The first calculation sub-module is then preferably designed to perform the following calculation for each morphological parameter PM_{i,j}:

PM_{i,j}=d⁰_{i,j}+d¹_{i,j}×PMP_{i1,j1}+d²_{i,j}×PMP_{i2,j2} . . . +dⁿ_{i,j}×PMP_{in,jn}

where d⁰_{i,j} . . . , dⁿ_{i,j} are predefined arithmetical coefficients.

Again preferably, the second calculation sub-module is designed to perform the following calculation for each product parameter PP_{i,j}:

PP_{i,j}=e^{p,q}_{i,j}×PM_{p,q}

where e^{p,q}_{i,j} is a predefined arithmetical coefficient.

In another variant, optionally in combination with any one or more of the preceding variants, the product being intended to be worn on at least one part of the body of a given person, the system includes means to determine the value of the principal characteristic morphological parameter(s) PMP_{i,j} of that part of the body of this given person.

It then also includes means for comparing the value of the principal characteristic morphological parameter(s) PMP_{i,j} of that part of the body of the given person, with the respective limits of the variation intervals determining each of the sizes of the group of sizes stored in the size storage means.

It finally includes means to select the size, from among all the sizes, which is defined by one or more variation intervals covering the respective values of the principal characteristic morphological parameter(s) PMP_{i,j} of that part of the body of the given person.

In yet another variant, optionally in combination with any one or more of the preceding variants, the variation intervals of the product parameters PP_{i,j} are defined with a tolerance equal to or less than ±4%, and preferably equal to ±3%, around a median value.

In yet another variant, optionally in combination with any one or more of the preceding variants, the part of the body being the face, the principal morphological parameters PMP_{i,j} are the biectocanthion distance, the biendocanthion distance, and the distance from the nasion to the subnasal point, whose respective definitions are recalled above.

In yet another variant, optionally in combination with any one or more of the preceding variants, the product is an item for sub-aquatic vision.

Finally, according to a third aspect, the invention relates to a method for the sizing of a product that is intended to be worn on at least one part of the body.

Characteristically, the method includes a step to select one or more principal morphological parameters PMP_{i,j} from among one or more characteristic morphological parameters PM_{i,j} of the part of the body, and corresponding to the distance between two characteristic morphological markers Mᵢ, Mⱼ of this part of the body.

It also includes a first step to calculate the value of one or more production parameters PP_{i,j} of the product, corresponding to the distance between two points NPᵢ, NPⱼ, in relation to the respective values of one or more characteristic principal morphological parameters PMP_{i,j} of the part of the body.

The method also includes a second step to calculate the value of the coordinates of each geometrically characteristic point NPᵢ of the product, in relation to the respective values of one or more production parameters PP_{i,j} of the product, these coordinates being expressed in a reference system centred on a particular point NP_{ref} from among the geometrically characteristic points NPᵢ of the product.

Finally, it includes a step to determine the respective values of the principal morphological parameter(s) PMP_{i,j} by selecting a given size from among a group of sizes defined by respective variation intervals of the principal morphological parameter(s) PMP_{i,j}, and by assigning the median value of each of the variation intervals defining the given size to each corresponding principal morphological parameter PMP_{i,j}.

In a first variant, for each production parameter PP_{i,j} of the product, the first calculation step performs the following calculation:

PP_{i,j}=c⁰_{i,j}+c¹_{i,j}×PMP_{i1,j1}+c²_{i,j}×PMP_{i2,j2}+ . . . +cⁿ_{i,j}×PMP_{in,in}

where c⁰_{i,j}, . . . , cⁿ_{i,j} are predefined arithmetical coefficients.

In a second variant, optionally in combination with the preceding variant, the first step to calculate the value of one or more production parameters PP_{i,j} of the product in relation to the value of one or more principal morphological parameters PMP_{i,j}, itself includes a first step to calculate the value of each morphological parameter PM_{i,j} in relation to the value of at least one of the principal morphological parameters PMP_{i,j}, and a second step to calculate the value of one or more production parameters PP_{i,j} of the product in relation to the value of at least one of the morphological parameters PM_{i,j}.

Preferably, the first step to calculate the value of each morphological parameter PM_{i,j} in relation to the value of at least one of the principal morphological parameters PMP_{i,j}, then performs the following calculation for each morphological parameter PM_{i,j}:

PM_{i,j}=d⁰_{i,j}+d¹_{i,j}×PMP_{i1,j1}+d²_{i,j}×PMP_{i2,j2}+ . . . +dⁿ_{i,j}×PMP_{in,in}

where d⁰_{i,j}, . . . , dⁿ_{i,j} are predefined arithmetical coefficients.

Also preferably, the second step to calculate the value of one or more production parameters PP_{i,j} of the product in relation to the value of at least one of the morphological parameters PM_{i,j} then performs the following calculation for each production parameter PP_{i,j} of the product:

PP_{i,j}=e^{p,q}_{i,j}×PM_{p,q}

where e^{p,q}_{i,j} is a predefined arithmetical coefficient.

In another variant, optionally in combination with any one or more of the preceding variants, the product being intended to be worn on at least one part of the body of a given person, the selection of a given size from among the group of sizes includes determining the value of the characteristic principal morphological parameter(s) PMP_{i,j} of that part of the body of this given person.

It also includes comparing the value of the characteristic principal morphological parameter(s) PMP_{i,j} of the part of the body of this given person, with the respective limits of the variation intervals defining each of the sizes of the group of sizes.

It finally includes selecting the size, from among the group of sizes, which is defined by one or more variation intervals covering the respective values of the characteristic principal morphological parameter(s) PMP_{i,j} of the part of the body of the given person.

In yet another variant, optionally in combination with any one or more of the preceding variants, the variation intervals of the product parameters PP_{i,j} are defined with a tolerance equal to or less than ±4%, and preferably equal to 3%, around a median value.

In yet another variant, optionally in combination with any one or more of the preceding variants, the part of the body being the face, the morphological parameters PMP_{i,j} are the biectocanthion distance, the biendocanthion distance, and the distance from the nasion to the subnasal point, whose respective definitions are recalled above.

Finally, in yet another variant, optionally in combination with any one or more of the preceding variants, the product is an item for sub-aquatic vision.

The invention can therefore be used advantageously to determine the size, from among a group of possible sizes, that will fit an individual person, through the provision of sizes based on a set of characteristic size parameters of the products which have a high level of morphological coverage.

The system is of relatively limited complexity and does not require extensive calculations, due in particular to the fact that the morphological parameters are reduced to a subset of principal morphological parameters, and a determination is made, by statistical study, of the arithmetical relationships between these parameters.

It is therefore particularly suitable for products whose geometry or morphology is not directly that of the part of the body on which these products are intended to be worn, as is the case, for example, for sub-aquatic vision products to be worn on the face, such as swimming goggles, and swimming or diving masks.

The system and the methods of the invention thus allow the establishment of a relationship between certain morphological characteristics of the product and certain morphological characteristics of the part of the body on which the product is to be worn, and determination of the size that will fit an individual person from among a group of possible sizes.

Other characteristics and advantages of the invention will become more clearly and fully apparent on reading the description that follows of preferred variants of embodiment of the system of the invention and of the method of implementation, given as non-limiting examples, with reference to the following appended drawings:

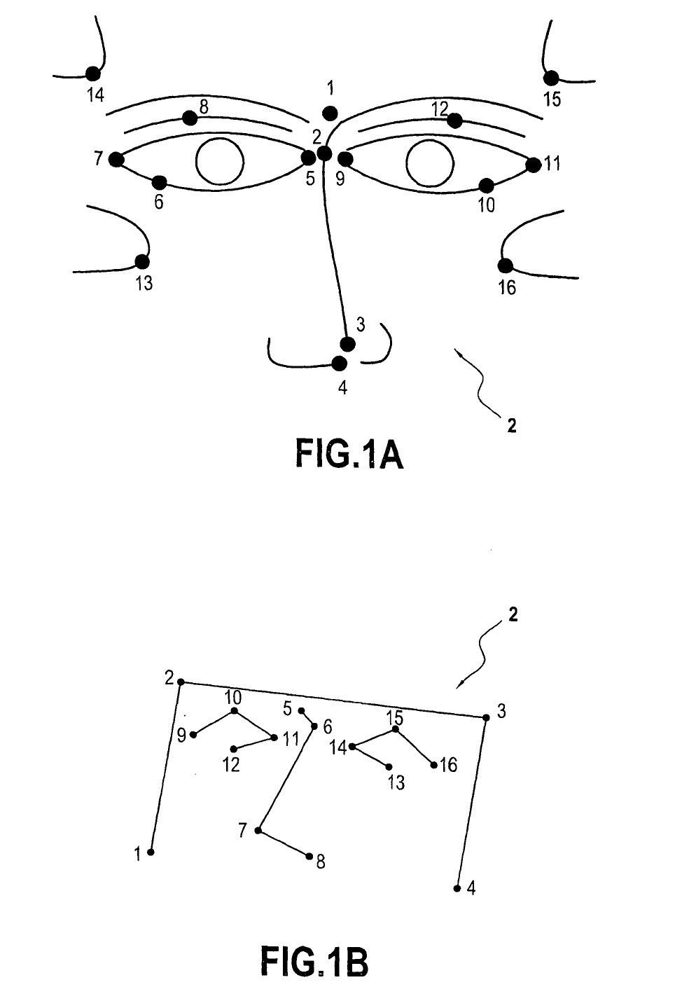

FIG. 1a: schematically shows the morphological markers in one variant of the invention,

FIG. 1b: schematically illustrates the morphological markers in one variant of the invention, in a so-called false 3D illustration,

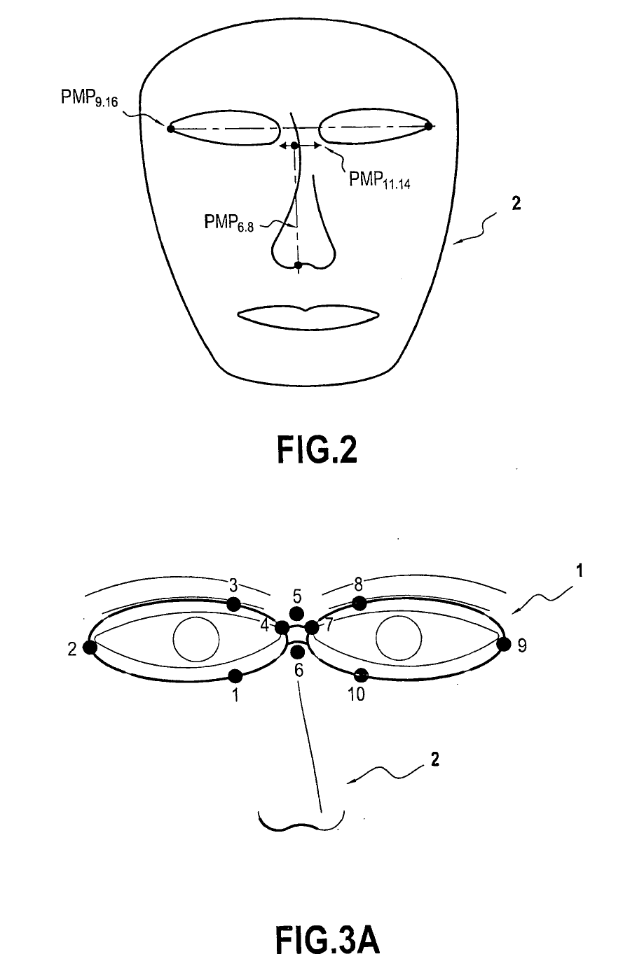

FIG. 2: is a schematic illustration of the principal morphological markers in one variant of the invention,

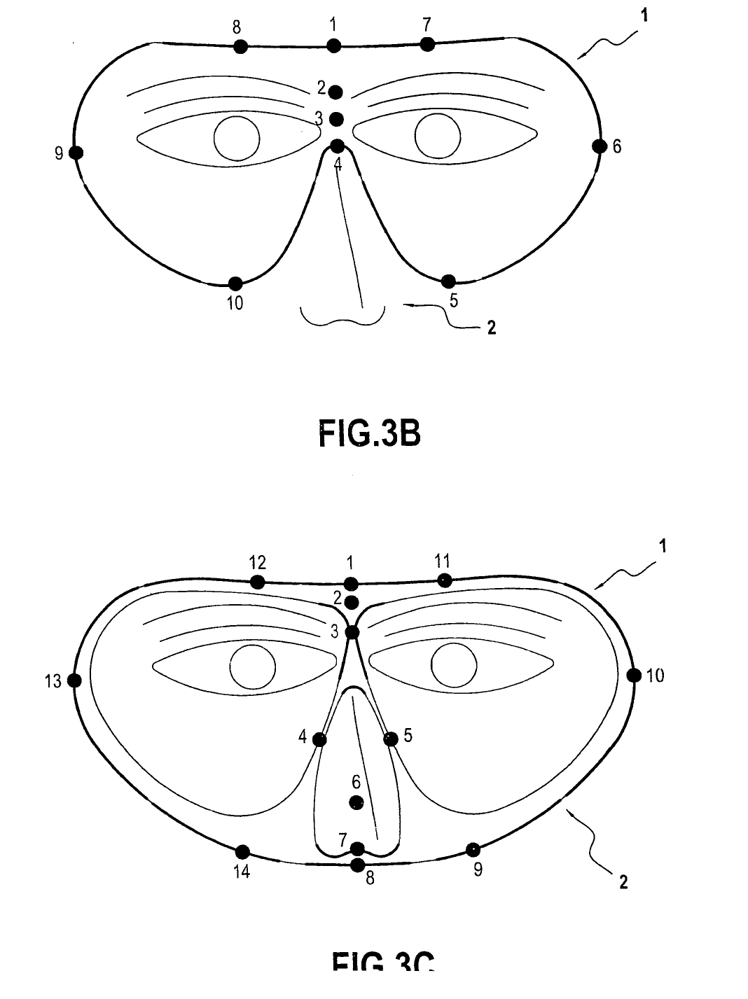

FIG. 3a: schematically illustrates the characteristic geometrical points of a first type of product,

FIG. 3b: schematically illustrates the characteristic geometrical points of a second type of product,

FIG. 3c: schematically illustrates the characteristic geometrical points of a third type of product,

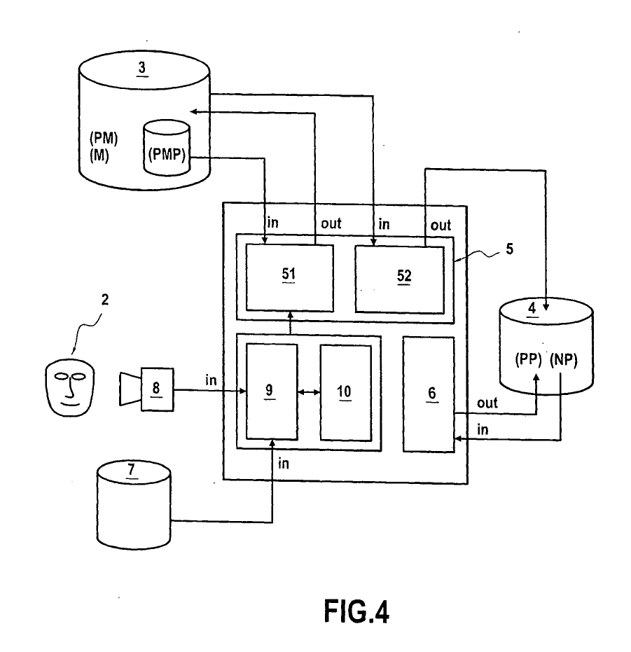

FIG. 4: schematically represents the system in one variant of the invention,

The remainder of the description concerns a particular application of the system and methods of the invention to so-called sub-aquatic vision products, in particular to swimming goggles and masks as well as to diving masks. Evidently, the description of this application is given by way of example and therefore does not limit the invention. The invention extends to applications concerning any type of product that is intended to be worn on at least one part of the body.

On the basis of a morphological and anthropometric study, a certain number of morphological markers Mᵢ, given in figure 1a, have been selected as being morphologically characteristic of a face 2.

The definition of these points is as follows:
M₁ is the median point of the frontal bone projecting outermost, located between the eyebrow arches, or the glabella.
M₂ is the median point located at the junction of the root of the nose and the forehead, or the nasion.
M₃ is the most anterior point of the tip of the nose, with the head being oriented in a so-called Frankfurt plane (the visual plane), or the pronasal.
M₄ is the point located to the apex of the angle formed by the lower edge of the septum and the top lip, or the subnasal.
M₅ is the first of the two points located at the internal (median) palpebral angles, outside of the lachrymal caruncles, or the first endocanthion.
M₆ is the first of the two points located at the localised break on the inferior structure of the orbita, at about one third of the distance from the first ectocanthion to the first endocanthion (M₅ to M₇), or the first sub-orbital.
M₇ is the first of the two points located at the external (lateral) palpebral angles on their posterior ridges, or the first ectocanthion.
M₈ is the first of the two median points located at the middle of the upper eyebrow arches and forming a break, or first suborbital.
M₉ is the second of the two points located at the internal (median) palpebral angles outside of the lachrymal caruncles, or the second endocanthion.
M₁₀ is the second of the two points located at the localised break in the inferior structure of the orbita, at about one third of the distance from the second ectocanthion to the second endocanthion (M₉ to M₁₁), or the second sub-orbital.
M₁₁ is the second of the two points located at the external (lateral) palpebral angles at their posterior ridge, or the second ectocanthion.
M₁₂ is the second of the two median points located at the middle of the upper eyebrow arches and forming a break, or the second sub orbital.
M₁₃ is the first of the two points forming kinds of flat spots located at the upper end of the junctions between the muscles of the jaw and the sub-orbital structures, or the first zygomatic bone.
M₁₄ is the first of the two points located above the lateral ends of the eyebrows, at the point where the temporal ridges undergo a slight variation in curvature (sometimes a point of inflection), or the first fronto-temporal.
M₁₅ is the second of the two points located above the lateral ends of the eyebrows, at the point where the temporal ridges undergo a slight variation in curvature (sometimes a point of inflection), or the second fronto-temporal.
M₁₆ is the second of the two points forming kinds of flat spots located at the upper end of the junctions between the muscles of the jaw and the sub-orbital structures, or the second zygomatic bone.

These morphological markers are illustrated in “false 3D” in FIG. 1b, in a different order. The points of FIG. 1a are renumbered in FIG. 1b in the following manner:
M₁: first zygomatic bone.
M₂: first fronto-temporal.
M₃: second fronto-temporal.
M₄: second zygomatic bone.
M₅: glabella.
M₆: nasion.
M₇: pronasal.
M₈: subnasal.
M₉: first ectocanthion.
M₁₀: first sub-orbital.
M₁₁: first endocanthion.
M₁₂: first sub-orbital.
M₁₃: second sub-orbital.
M₁₄: second endocanthion.
M₁₅: second sub-orbital.
M₁₆: second ectocanthion.

This order of the morphological markers Mᵢ facilitates modelling. It can effectively be performed in “a single process”, and in an easily repeatable order.

From these morphological markers, morphological parameters PM_{i,j} are defined, which are morphologically characteristic of a face 2, and which correspond to the distances between two morphological markers Mᵢ, Mⱼ. Thus, for example, PM_{1,2} designates the distance from M₁ to M₂.

From statistical tests on samples representing different populations, corresponding to different morphological types, a subset of these morphological parameters PM_{i,j} was selected. These parameters form principal morphological parameters PMP_{i,j}, and are illustrated FIG. 2.

These key parameters are those generating the greatest differentiation from one product to another. In particular, these parameters have a significant influence on comfort and leak resistance, when applied to items for sub-aquatic vision.

In this example, these principal morphological parameters are three in number:

PMP_{9,16}=PM_{9,16}: the distance between the outer ends of the eyes or the biectocanthion distance.

PMP_{11,14}=PM_{11,14}: the distance between inner ends of the eyes or the bi-endocanthion distance.

PMP_{6,8}=PM_{6,8}: the height of the nose or the nasion to subnasal distance.

These three principal parameters are therefore used for identifying morphotypes. They are thus at the basis of the system and methods of the invention, in this example of application to items for sub-aquatic vision.

A matrix of coefficients d^{k}_{i,j} is then determined, and is used to recalculate all the morphological parameters PM_{i,j} from the subset of principal morphological parameters PMP_{i,j}.

Therefore, for example:

PM_{10,12}=d⁰_{10,12}+d¹_{10,12}×PMP_{9,16}+d²_{10,12}×PMP_{11,14}+d³_{10,12}×PMP_{6,8}

Through this reduction in the number of morphological parameters to a smaller number of principal morphological parameters, it is possible to simplify calculations and individual measurements to a considerable extent, since these measurements are limited to this number of principal morphological parameters.

Once identified and selected, the principal morphological parameters are used to represent the populations targeted by the system of the invention, in relation to these principal morphological parameters.

The following graphs, for the example in which the part of the body concerned is the face, show population ellipses according to two of the three principal morphological parameters.

Graph A therefore shows the positioning of the population ellipses in relation to the width of the face and the width of the nose, and hence in relation to principal morphological parameters PMP_{9,16} and PMP_{11,14} .

Graph B below shows the positioning of the population ellipses in relation to the width of the face and the height of the nose, and hence in relation to the principal morphological parameters PMP_{9,16} and PMP_{6,8}.

From these graphs, a system of sizes is created. Each size is determined by variation intervals of the principal morphological parameters. These intervals are defined around a mean or median value, with a tolerance around this value, using sensitivity tests based on comfort and leak resistance in the exemplary application to items for sub-aquatic vision.

The aim is to obtain a system of sizes that provides maximum coverage of the different morphology types studied and identified, while controlling the number of sizes by limiting their number as much as possible, and by guaranteeing a high level of satisfaction for user populations notably in terms of comfort and leak resistance.

In one particular example, a coverage rate of 90% was obtained with a high satisfaction level.

As an example, graph C below is a summary table of the intervals determining 7 sizes, giving a 90% coverage rate of the populations concerned with a high satisfaction rating.

Graph D below illustrates a size grading system in relation to the width of the face and the width of the nose, and hence in relation to the principal morphological parameters PMP_{9,16} and PMP_{11,14}.

Graph E below illustrates a size grading system in relation to the width of the face and the height of the nose, and hence in relation to the principal morphological parameters PMP_{9,16} and PMP_{6 ,8}.

It can therefore be seen from these graphs that the different population ellipses are properly covered by the different sizes represented by squares centred on pairs of values of the two principal morphological parameters, PMP_{9,16} and PMP_{11,14}.

In a given size, and hence in a given square, the size is considered to be ideal (very high satisfaction rating) for a person for whom the values of the two principal morphological parameters, PMP_{9,16} and PMP_{11,14}, correspond to the central point of the square.

In a given size, and hence in a given square, the further the distance from the centre, the more the satisfaction rating becomes reduced, whilst still remaining acceptable.

Next, for each product, points NPᵢ are selected, which are geometrically characteristic of this product.

These geometrically characteristic points NPᵢ are shown FIGS. 3a, 3b and 3c, in the three examples of swimming goggles, swimming mask and diving mask respectively.

These geometrically characteristic points NPᵢ of each product are used to determine product parameters PP_{i,j}, which correspond to the distances between two points, NPᵢ and NPⱼ. Thus, for example, PP_{1,2} indicate the distance from NP₁ to NP₂.

In each of the three cases represented respectively in FIGS. 3a to 3c, a certain number of tests are then used to link each of the product parameters PP_{i,j} to at least one morphological parameter PM_{i,j} using an arithmetical relationship of the type PP_{i,j}=e^{p,q}_{i,j}×PM_{p,q}.

Also, a point NP_{ref} is chosen from among points NPᵢ, as the centre of a reference system in which the coordinates (xᵢ, yᵢ, zᵢ) of each point NPᵢ can be expressed.

The aforementioned tests are also used to link these coordinates (xᵢ, yᵢ, zᵢ) to one or more product parameters PP_{i,j}.

We are therefore now in possession of the information necessary for the manufacture of a product of a given size, namely the coordinates (xᵢ, yᵢ, zᵢ) and the distances PP_{i,j}.

Additionally a link is available firstly between the principal morphological parameters PMP_{i,j} and morphological parameters PM_{i,j}, and secondly between morphological parameters PM_{i,j} and product parameters PP_{i,j}.

It can therefore be said that a link is available between the principal morphological parameters PMP_{i,j} and the product parameters PP_{i,j}. This link is therefore of the form:

PP_{i,j}=c⁰_{i,j}+c¹_{i,j}×PMP_{9,16}+c²_{i,j}×PMP_{11,14}+c³_{i,j}×PMP_{6,8}

where c^{k}_{i,j} are statistically determined coefficients, or:

PP_{i,j}=c⁰_{i,j}+e^{9,16}_{i,j}×d¹_{i,j}×PMP_{9,16}+e^{11,14}_{i,j}×d²_{i,j}×PMP_{11,14}+e^{6,8}_{i,j}×d³_{i,j}×PMP_{6,8}

Thus, by determining the values of the principal morphological parameters PMP_{i,j} of a person by direct measurement on this person for example, it is possible to deduce the values of the product parameters PP_{i,j} corresponding to this given person.

It is then possible to produce a “tailor-made” product for the person concerned.

For a product range comprising several sizes, for example seven sizes as shown in the table in Graph C, it is also possible to determine the appropriate size for this given person, by comparing measured values of the principal morphological parameters PMP_{i,j} of this person with the limit values of the intervals determining each size.

By means of the link explained above, between the principal morphological parameters PMP_{i,j} and the product parameters PP_{i,j}, the sizes can just as well be determined using the variation intervals of the different product parameters PP_{i,j}, each centred on a mean or median value corresponding to the value of the associated product parameter. These intervals are then preferably determined with a tolerance equal to ±3% around the median value, and at all events equal to or less than ±4% around this median value.

As explained above, the preliminary study, used for size grading, ensures a maximum rate of coverage of the different morphology types studied and identified, whilst controlling the number of sizes by limiting their number as much as possible, and guaranteeing a high level of satisfaction by populations for comfort and leak resistance criteria in particular.

FIG. 4 schematically illustrates the system in one variant of the invention.

This system includes storage means 3 that can be used to store the definition of the morphological markers Mi and morphological parameters PM_{i,j}, and the values of these parameters PM_{i,j}. Among these, a subset forms the subset of principal morphological parameters PMP_{i,j}.

The system also includes storage means 4 to store the definition of the characteristic points NPᵢ of the product (optionally including their coordinates in a reference system centred on a particular point NP_{ref}), product parameters PP_{i,j} and the values of these parameters PP_{i,j}.

Additionally, the different sizes and their respective definitions, namely the variation intervals of the values of the principal morphological parameters PMP_{i,j} or of the product parameters PP_{i,j}, are stored in storage means 7.

A processing device includes a module 5 that can be used to calculate the values of the product parameters PP_{i,j} in relation to the values of the principal morphological parameters PMP_{i,j}.

Advantageously, this module 5 includes two sub-modules 51, 52.

The first sub-module 51 is initially used to calculate the value of the morphological parameters PM_{i,j} in relation to the values of the principal morphological parameters PMP_{i,j}.

The second sub-module 52 is then used to calculate the value of the product parameters PP_{i,j} in relation to the values of the morphological parameters PM_{i,j} calculated by the first sub-module 51.

With said system, it is therefore possible to manufacture a tailor-made product adapted to fit a given person, or to select the size that fits this given person from among all the sizes available, provided that the values are known of the principal morphological parameters PMP_{i,j} of the part 2 of the body of the person concerned.

These values, if known beforehand, can be entered into the system using conventional data entry means, and can then be processed by comparison means 9 as explained below.

These values can also be determined using determination means 8 that use conventional biometric measurement techniques. It is possible, for example, to envisage the use of a photographic appliance associated with processing and measurement software. It is also possible to envisage the use of light fringes reflected by a mirror onto the part 2 of the body of the person, associated with a device for detection of these light and measurement fringes.

These values are then transmitted to the comparison means 9. These means are able to transmit the same directly to the calculation module 5 in order to determine the values of the corresponding product parameters PP_{i,j}, for manufacture of a tailor-made product for example. It is also able to consult the storage means 7 memorizing the respective definitions of each available size, and then to transmit this data to the selection means 10 which select the corresponding size, namely the size determined by variation intervals of the principal morphological parameters PMP_{i,j} covering the respective values of these different principal morphological parameters PMP_{i,j} relating to part 2 of the body of the given person.

It is noted here that the entirety of the foregoing description is given by way of example, and therefore does not limit the invention.

In particular, the different storage means 3, 4, 7 are illustrated separately. This separation is merely a logic illustration however, and is not physical, which means that they can therefore be brought together physically in a single storage means such as a file or a database for example.

This also applies to the different modules or sub-modules 5, 51, 52, 6 or to the various means 9, 10. Their illustration as separate modules or means is only a logic illustration of the architecture and arrangement of these modules or means, and they can therefore be brought together physically in a single means or module comprising a processor or a processing unit for example and several computer programs for example.

1.-26. (canceled)

27. A method for the creation of a sizing system of the grading type, which can be used to determine one or more sizes, for a product that is intended to be worn on at least one part of the body, comprising the steps of:
selecting and storing in a means for the storage of one or more principal morphological parameters (PMP_{i,j}) from among one or more characteristic morphological parameters (PM_{i,j}) of said part of the body, and corresponding to the distance between two morphological markers (Mᵢ, Mⱼ) that are characteristic of said part of the body;
selecting and storing in a means for the storage of at least one product parameter (PP_{i,j}), corresponding to the distance between two points (NPᵢ, NPⱼ) that are geometrically characteristic of said product;
providing in a first step a first module for calculating the value of each product parameter (PP_{i,j}) according to the value of at least one of said principal morphological parameters (PMP_{i,j}), said first step further comprising:
i. a first statistical calculation to determine a first arithmetical relation between each product parameter (PP_{i,j}) and at least one of said principal morphological parameters (PMP_{i,j}),
ii. a first step for the storage of said first arithmetical relation in a storage means;
providing in a second step a second module for calculating the value of coordinates of each geometrically characteristic point (NPᵢ) of said product according to at least one of said product parameters (PP_{i,j}), said coordinates being expressed in a reference system centered on a particular point (NP_{ref}) from among said geometrically characteristic points (NPᵢ) of said product, said second step further comprising:
i. a second statistical calculation step to determine a second arithmetical relation between said coordinates of each geometrically characteristic point (NPᵢ) of said product and at least one of said product parameters (PP_{i,j}),
ii. a second step for the storage of said second arithmetical relation in a storage means;
providing a third statistical calculation step to determine one or more sizes, each of said sizes being determined by particular respective variation intervals of said principal morphological parameter or parameters (PMP_{i,j}), or by respective particular variation intervals of said product parameter or parameters (PP_{i,j}), and being stored in a storage means.

28. A method according to claim 27, wherein for each product parameter (PP_{i,j}), said first statistical calculation step further comprises the step of;
including a statistical calculation step to determine arithmetical coefficients c⁰_{i,j}, . . . , cⁿ_{i,j}, such that:
PP_{i,j}=c⁰_{i,j}+c¹_{i,j}×PMP_{i1,j1}+c²_{i,j}×PMP_{i2,j2}+ . . . +cⁿ_{i,j}×PMP_{in,jn}
and wherein said first storage step further includes a step for storage of said coefficients in said storage means.

29. A method according to claim 27, wherein said first statistical calculation step further comprises the steps of:
providing a first intermediate statistical calculation step to determine a first intermediate arithmetical relation between each morphological parameter (PM_{i,j}) and at least one of said principal morphological parameters (PMP_{i,j}),
providing a second intermediate statistical calculation step to determine a second intermediate arithmetical relation between each product parameter (PP_{i,j}) and at least one of said morphological parameters (PM_{i,j}),
wherein said first storage step further comprises the steps of:
providing a first intermediate step for storage of said first intermediate arithmetical relation; and
providing a second intermediate step for storage of said second intermediate arithmetical relation.

30. A method according to claim 29, wherein for each morphological parameter (PM_{i,j}), said first intermediate statistical calculation step further comprises the step of;
including a statistical calculation step to determine arithmetical coefficients d⁰_{i,j}, . . . , dⁿ_{i,j} such that:
PM_{i,j}=d⁰_{i,j}+d¹_{i,j}×PMP_{i1,j1}+d²_{i,j}×PMP_{i2,j2}+ . . . +dⁿ_{i,j}×PMP_{in,jn}
wherein said first intermediate storage step includes a step for the storage of said coefficients in said storage means.

31. A method according to claim 29, wherein for each product parameter (PP_{i,j}), said second intermediate statistical calculation step further comprises the step of;
providing a statistical calculation step to determine an arithmetical coefficient, e^{p,q}_{i,j}, such that:
PP_{i,j}=e^{p,q}_{i,j}×PM_{p,q},
wherein said second intermediate storage step includes a step for the storage of said coefficient in said storage means.

32. A method according to claim 27, wherein said variation intervals of said product parameters (PP_{i,j}) are defined with a tolerance that is less than or equal to about 4%, preferably less than or equal to about 3%, around a median value.

33. A method according to claim 27, wherein said part of the body is a face and said morphological parameters (PMPᵢⱼ) are a biectocanthion distance, a biendocanthion distance, and a distance from a nasion to a subsnasal point.

34. A method according to claim 27, wherein said method produces a subaquatic optical product.

35. A sizing system of the grading type, which can be used in particular to determine one or more sizes, for a product intended to be worn on at least one part of the body, comprising:
a means for storage of the respective values of one or more characteristic morphological parameters (PM_{i,j}) of said part of the body and corresponding to the distance between two characteristic morphological markers (Mᵢ, Mⱼ) of said part of the body, at least one of said morphological parameters (PM_{i,j}) being a principal morphological parameter (PMP_{i,j});
a means for storage of the respective values of one or more geometrically characteristic product parameters (PP_{i,j}) of said product and corresponding to the distance between two geometrically characteristic points (NPᵢ, NPⱼ) of said product;
a first module for calculating the value of each product parameter (PP_{i,j}) according to the value of at least one of said principal morphological parameters (PMP_{i,j});
a second module for calculating the value of coordinates of each geometrically characteristic point (NPᵢ) of said product according to at least one of said product parameters (PP_{i,j}), said coordinates being expressed in a reference system centered on a particular point (NP_{ref}) from among said geometrically characteristic points (NPᵢ) of said product,
a means for storing at least one sized determined by respective particular variation intervals of said principal morphological parameter or parameters (PMP_{i,j}), or by respective particular variation intervals of said product parameter or parameters (PP_{i,j}).

36. A system according to claim 36, wherein said first calculation module is designed to perform the following calculation for each product parameter (PP_{i,j}):
PP_{i,j}=c⁰_{i,j}+c¹_{i,j}×PMP_{i1,j1}+c²_{i,j}×PMP_{i2,j2}+ . . . +cⁿ_{i,j}×PMP_{in,jn}
where c⁰_{i,j}, . . . , cⁿ_{i,j} are predetermined arithmetical coefficients.

37. A system according to claim 35, wherein said first module for calculating the value of each product parameter (PP_{i,j}) according to the value of at least one of said principal morphological parameters (PMP_{i,j}) includes:
a first sub-module for calculating the value of each morphological parameter (PM_{i,j}) according to the value of at least one of said principal morphological parameters (PMP_{i,j})
a second sub-module for calculating the value of each product parameter (PP_{i,j}) according to the value of at least one of said morphological parameters (PM_{i,j}).

38. A system according to claim 37, wherein said first calculation sub-module is designed to perform the following calculation for each morphological parameter (PM_{i,j}):
PM_{i,j}=d⁰_{i,j}+d¹_{i,j}×PMP_{i1,j1}+d²_{i,j}×PMP_{i2,j2}+ . . . +dⁿ_{i,j}×PMP_{in,jn}
where d⁰_{i,j, . . . , d}ⁿ_{i,j} are predetermined arithmetical coefficients.

39. A system according to claim 37, wherein said second calculation sub-module is designed to perform the following calculation for each product parameter (PP_{i,j}):
PP_{i,j}=e^{p,q}_{i,j}×PM_{p,q}
where e^{p,q}_{i,j} is a predetermined arithmetical coefficient.

40. A system according to claim 35, further comprising:
means for determining the value of said characteristic principal morphological parameter or parameters (PMP_{i,j}) of said part of the body of a person,
means for comparing the value of the said characteristic principal morphological parameter or parameters (PMP_{i,j}) of said part of the body of said person, with the respective boundaries of the said variation intervals determining each of said sizes of said set of said sizes stored in said storage means,
means for selecting the size, from among said set of said sizes stored in said storage means, which is determined by one or more variation intervals to which belong the respective values of said characteristic principal morphological parameter or parameters (PMP_{i,j}) of said part of the body of said person.

41. A system according to claim 35, wherein said variation intervals of said product parameters (PP_{i,j}) are defined with a tolerance that is less than or equal to about 4%, and preferably less than or equal to about 3%, around a median value.

42. A system according to claim 35, wherein said part of the body is a face and said principal morphological parameters (PMP_{i,j}) are a bietocanthion distance, a biendocanthion distance, and a distance from a nasion to a subnasal point.

43. A system according to claim 35, wherein said product is a subaquatic optical product.

44. A sizing method of the grading type, which can be used to determine one or more sizes for a product intended to be worn on at least one part of the body, comprising the steps of:
providing a step for the selection, from a means of storage, of one or more principal morphological parameters (PMP_{i,j}) from among one or more morphological parameters (PM_{i,j}) stored in said means of storage and characteristic of said part of the body, and corresponding to the distance between two characteristic morphological markers (Mi, Mⱼ) of said part of the body;
providing a first calculation step, by a first calculation module, of the value of one or more production parameters (PP_{i,j}) of the product, corresponding to the distance between two geometrically characteristic points (NPᵢ, NPⱼ) of said product, according to the respective values of one or more of the said characteristic principal morphological parameters (PMP_{i,j}) of said part of the body,
providing a second calculation step, by a second module, of the value of coordinates of each geometrically characteristic point (NPᵢ) of said product, according to the respective values of one or more production parameters (PP_{i,j}) of the product, said coordinates being expressed in a reference system centered on a particular point (NP_{ref}) from among said geometrically characteristic pints (NPᵢ) of said product,
providing a step for determining said respective values of said principal morphological parameter or parameters (PMP_{i,j}) by:
i. selecting from a means for storing a given size, from among a set of sizes determined by respective variation intervals of said principal morphological parameter or parameters (PMP_{i,j}),
ii. assigning the median value of each of said variation intervals determining said given size to each corresponding principal morphological parameter (PMP_{i,j}).

45. A method according to claim 44, wherein for each production parameter (PP_{i,j}) of said product, said first calculation step includes;
performing the following calculation:
PP_{i,j}=c⁰_{i,j}+c¹_{i,j}×PMP_{i1,j1}+c²_{i,j}×PMP_{i2,j2}+ . . . +cⁿ_{i,j}×PMP_{in,jn}
where c⁰_{i,j}, . . . , cⁿ_{i,j} are predetermined arithmetical coefficients.

46. A method according to claim 44, wherein said first step of calculating the value of one or more production parameters (PP_{i,j}) of the product according to the value of one or more principal morphological parameters (PMP_{i,j}), further includes:
providing a first calculation step, using a first sub-module for calculating the value of each morphological parameter (PM_{i,j}) according to the value of at least one of said principal morphological parameters (PMP_{i,j}),
providing a second calculation step, using a second sub-module for calculating the value of one or more production parameters (PP_{i,j}) of said product according to the value of at least one of said morphological parameters (PM_{i,j}).

47. A method according to claim 46, wherein said first step for calculating the value of each morphological parameter (PM_{i,j}) according to the value of at least one of said principal morphological parameters (PMP_{i,j}), further includes the step of;
performing the following calculation for each morphological parameter (PM_{i,j}):
PM_{i,j}=d⁰_{i,j}+d¹_{i,j}×PMP_{i1,j1}+d²_{i,j}×PMP_{i2,j2}+ . . . +dⁿ_{i,j}×PMP_{in,jn}
where d⁰_{i,j}, . . . , dⁿ_{i,j} are predetermined arithmetical coefficients.

48. A method according to claim 46, wherein said second step for calculating the value of one or more production parameters (PP_{i,j}) of said product according to the value of at least one of the said morphological parameters (PM_{i,j}) further includes the step of;
performing the following calculation for each production parameter (PP_{i,j}) of said product:
PP_{i,j}=e^{p,q}_{i,j}×PM_{p,q}
where e^{p,q}_{i,j} is a predetermined arithmetical coefficient.

49. A method according to claim 44, wherein said selection of a given size from among said set of sizes includes:
determining, by determination means, the value of said characteristic principal morphological parameter or parameters (PMP_{i,j}) of said part of the body of a person,
comparing, by comparison means, the value of said characteristic principal morphological parameter or parameters (PMP_{i,j}) of said part of the body of said person, with the respective boundaries of said variation intervals determining each of said sizes of said set of sizes,
selecting, by selection means, the size from among said set of said sizes, which is determined by one or more variation intervals to which belong the respective values of said characteristic principal morphological parameter or parameters (PMP_{i,j}) of said part of the body of said person.

50. A method according to claim 44, wherein said variation intervals of said product parameters (PP_{i,j}) are defined with a tolerance that is less than or equal to about 4%, and preferably less than or equal to about 3%, around a median value.

51. A method according to claim 44, wherein said part of the body is a face and said morphological parameters (PMP_{i,j}) are a biectocanthion distance, a biendocanthion distance, and a distance from a nasion to a subnasal point.

52. A method according to claim 44, wherein said method produces a subaquatic optical product.
